(19) United States
(12) Patent Application Publication
(10) Pub. No.: US 2023/0045900 A1
(43) Pub. Date: Feb. 16, 2023

(54) METHOD AND SYSTEM FOR EVALUATING PERFORMANCE OF OPERATION RESOURCES USING ARTIFICIAL INTELLIGENCE (AI)

(71) Applicant: HCL Technologies Limited, New Delhi (IN)

(72) Inventors: NAVIN SABHARWAL, New Delhi (IN); AMIT AGRAWAL, Mathura (IN)

(73) Assignee: HCL Technologies Limited

(21) Appl. No.: 17/402,684

(22) Filed: Aug. 16, 2021

(51) Int. Cl. G06Q 10/06; G06K 9/62; G06N 3/08; G06N 3/04

(52) U.S. Cl. CPC G06Q 10/06398; G06K 9/623; G06K 9/628; G06K 9/6288; G06N 3/08; G06N 3/0454

(57) ABSTRACT

A method and system for evaluating performance of operation resources using Artificial Intelligence (AI) is disclosed. In some embodiments, the method includes receiving, each of a plurality of performance parameters associated with a set of operation resources. The method further includes determining a set of features for each of the plurality of performance parameters. The method further includes creating one or more feature vectors corresponding to each of the plurality of performance parameters. The one or more feature vectors are created based on a first pre-trained machine learning model. The method further includes assessing the one or more feature vectors, based on the first pre-trained machine learning model and classifying the set of operation resources into one of a set of performance categories based on the assessing of the one or more feature vectors. The method further includes evaluating performance of at least one of the set of operation resources.

### TECHNICAL FIELD

Generally, the disclosure relates to Artificial Intelligence (AI). More specifically, the disclosure relates to a method and system for evaluating performance of employees (such as, operation resources) using AI based technologies.

### BACKGROUND

Typically, operation resources may be evaluated for performance on various factors, such as, but not limited to, type and priority of issues solved, complexity of issues, an expertise level and a resolution quality of issues. This makes it difficult for reviewers to provide feedback manually for performance evaluation to the operation resources for time taken to solve issues and complexity of issues. However, such performance evaluation may be crucial in any organization for factors, such as, but not limited to, providing an appraisal or a rating that clearly distinguishes an individual operation resource amongst others and also providing the training to the operation resource to enhance the skillset, collaboration amongst operation resources, based on the performance evaluation.

Accordingly, there is a need for a method and system for evaluating the performance of operation resources.

### SUMMARY

In accordance with one embodiment, a method of evaluating performance of operation resources using AI is disclosed. The method may include receiving each of a plurality of performance parameters associated with a set of operation resources. The method may include determining a set of features for each of the plurality of performance parameters, based on the each of a plurality of performance parameters. The method may further include creating, by the AI based performance evaluation system, one or more feature vectors corresponding to each of the plurality of performance parameters, based on the set of features determined for each of the plurality of performance parameters. In accordance with an embodiment, the one or more feature vectors are created based on a first pre-trained machine learning model. The method may further include assessing the one or more feature vectors, based on the first pre-trained machine learning model. The method may further include classifying the set of operation resources into one of a set of performance categories based on the assessing of the one or more feature vectors. The method may further include the performance of at least one of the set of operation resources, based on an associated category in the set of performance categories, in response to the classifying.

In another embodiment, a system for evaluating performance of operation resources using Artificial Intelligence (AI) is disclosed. The system includes a processor and a memory communicatively coupled to the processor. The memory may store processor-executable instructions, which, on execution, may causes the processor to receive each of a plurality of performance parameters associated with a set of operation resources. The processor-executable instructions, on execution, may further cause the processor to determine a set of features for each of the plurality of performance parameters, based on the each of a plurality of performance parameters. The processor-executable instructions, on execution, may further cause the processor to create one or more feature vectors corresponding to each of the plurality of performance parameters, based on the set of features determined for each of the plurality of performance parameters. In accordance with an embodiment, the one or more feature vectors are created based on a first pre-trained machine learning model. The processor-executable instructions, on execution, may further cause the processor to assess the one or more feature vectors, based on the first pre-trained machine learning model. The processor-executable instructions, on execution, may further cause the processor to classify the set of operation resources into one of a set of performance categories based on the assessing of the one or more feature vectors. The processor-executable instructions, on execution, may further cause the processor to evaluate the performance of at least one of the set of operation resources, based on an associated category in the set of performance categories, in response to the classifying.

In yet another embodiment, a non-transitory computer-readable medium storing computer-executable instruction for evaluating performance of operation resources using Artificial Intelligence (AI) is disclosed. The stored instructions, when executed by a processor, may cause the processor to perform operations including receiving each of a plurality of performance parameters associated with a set of operation resources. The operations may further include determining a set of features for each of the plurality of performance parameters, based on the each of a plurality of performance parameters. The operations may further include creating one or more feature vectors corresponding to each of the plurality of performance parameters, based on the set of features determined for each of the plurality of performance parameters. In accordance with an embodiment, the one or more feature vectors are created based on a first pre-trained machine learning model. The operations may further include assessing the one or more feature vectors, based on the first pre-trained machine learning model. The operations may further include classifying the set of operation resources into one of a set of performance categories based on the assessing of the one or more feature vectors. The operations may further include evaluating the performance of at least one of the set of operation resources, based on an associated category in the set of performance categories, in response to the classifying.

It is to be understood that both the foregoing general description and the following detailed description are exemplary and explanatory only and are not restrictive of the invention, as claimed.

### BRIEF DESCRIPTION OF THE DRAWINGS

The present disclosure can be best understood by reference to the following description taken in conjunction with the accompanying drawing figures, in which like parts may be referred to by like numerals

FIG. 1 illustrates a block diagram of an environment of an AI based performance evaluation system for evaluating performance of operation resources, in accordance with an embodiment.

FIG. 2 illustrates a functional block diagram of various modules of an AI based performance evaluation system for evaluating performance of operation resources, in accordance with an embodiment.

FIGS. 3A-3C collectively illustrate tabular representations for input data corresponding to performance parameters of operation resources, in accordance with an exemplary embodiment.

FIG. 4 illustrates an AI based performance evaluation system trained on a reinforcement learning approach, in accordance with an exemplary embodiment.

FIG. 5 illustrates an AI based performance evaluation system that uses inverse reinforcement learning to predict a set of algorithms to perform hyperparameter tuning, in accordance with an exemplary embodiment.

FIG. 6 illustrates creating a new environment for an AI based performance evaluation system with a transfer learning approach, in accordance with an exemplary embodiment.

FIG. 7 illustrates a flowchart of a method for evaluating performance of operation resources using AI, in accordance with an embodiment.

FIG. 8 illustrates a flowchart of a method for ranking operation resources for performance evaluation of the operation resources, in accordance with an embodiment.

### DETAILED DESCRIPTION

The following description is presented to enable a person of ordinary skill in the art to make and use the disclosure and is provided in the context of particular applications and their requirements. Various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art will realize that the disclosure might be practiced without the use of these specific details. In other instances, well-known structures and devices are shown in block diagram form in order not to obscure the description of the disclosure with unnecessary detail. Thus, the disclosure is not intended to be limited to the embodiments shown, but is to be accorded the widest scope consistent with the principles and features disclosed herein.

While the disclosure is described in terms of particular examples and illustrative figures, those of ordinary skill in the art will recognize that the disclosure is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions). Software and firmware can be stored on computer-readable storage media. Some other processes can be implemented using analog circuitry, as is well known to one of ordinary skill in the art. Additionally, memory or other storage, as well as communication components, may be employed in embodiments of the invention.

The present disclosure tackles limitations of existing systems to facilitate performance evaluation of a set of operation resources (hereinafter referred as operation resources) using an AI based performance evaluation system. The present disclosure evaluates performance of the operation resources based on a plurality of parameters associated with each operation resource. The plurality of performance parameters may include, but is not limited to, at least one of efficiency of a developed product associated with a module developed for a product, complexity of the developed product, types of support received from peers, feedback or rating received from managers, quality of the module developed for the product, and technical skills of each of the set of operation resources. Further, the present disclosure may facilitate computation of ranks of each of the set of operation resources.

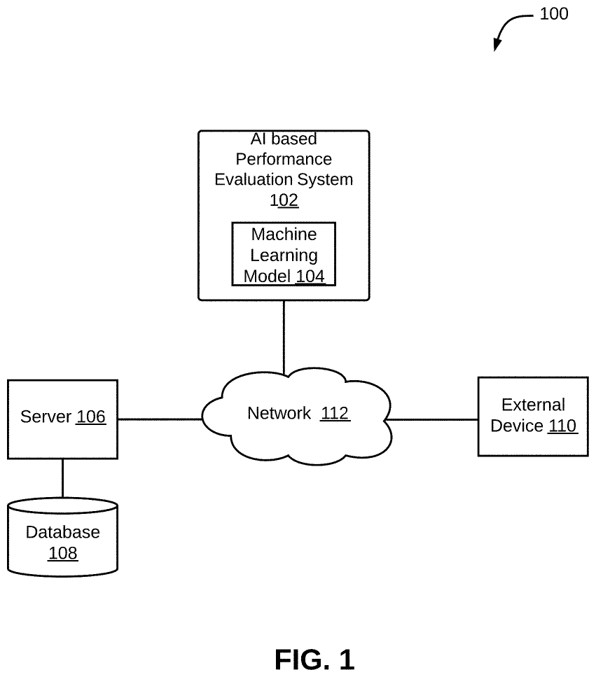

In accordance with an embodiment, the disclosed system (the AI based performance evaluation system) may be trained by exposing to a new environment during initial training process. Further, the disclosed system may re-evaluate or re-rank each of the set of operation resources using performance of each of the set of operation resources. The disclosed system may identify at least one operation resource from a set of operation resources that may need training in certain technology, topic or skill. The disclosed system may incorporate feedback or rating given by other operational resources at various levels. The disclosed system may facilitate performance evaluation of operation resources based on collaboration among other team members, solution complexity and time taken to solve issues. In accordance with an embodiment, the disclosed system (the AI based performance evaluation system) may also integrate with employee collaboration system to use assistance provided by an operations resource to another one as one of the factors during performance evaluation. These advantages have been explained in detail in conjunction with FIG. 1 to FIG. 8.

Referring now to FIG. 1, a functional block diagram for an environment 100 of an AI based performance evaluation system for evaluating performance of operation resources is illustrated, in accordance with an embodiment. With reference to FIG. 1, there is shown an AI based performance evaluation system 102, a machine learning (ML) model 104, a server 106, a database 108, an external device 110, and a communication network 112 (hereinafter referred as a network 112).

The AI based performance evaluation system 102 may be communicatively coupled to the server 106 and the external device 110, via the network 112. Further, the AI based performance evaluation system 102 may be communicatively coupled to the database 108 of the server 106, via the network 112. A user or an administrator (not shown in the FIG. 1) may interact with the AI based performance evaluation system 102 via a user interface.

The AI based performance evaluation system 102 may include suitable logic, circuitry, interfaces, and/or code that may be configured to evaluate performance of operation resources of an organization, based on a plurality of performance parameters associated with the operation resources. Such operation resources may be from a same team or a different team in the organization and working at different levels of a hierarchy in the organization. The plurality of performance parameters may include, at least one of type of, but not limited to, issues solved, priority of the issues solved, complexity of issues, resolution quality of issues, types of support received from peers, types of support provided to peers, feedback or rating received from managers, expertise level, technical skills, positive feedback data, negative feedback data, neutral feedback data of each of the set of operation resources.

Examples of the AI based performance evaluation system 102 may include, but are not limited to, a server, a desktop, a laptop, a notebook, a tablet, a smartphone, a mobile phone, an application server, or the like. By way of an example, the AI based performance evaluation system 102 may be implemented as a plurality of distributed cloud-based resources by use of several technologies that are well known to those skilled in the art. Other examples of implementation of the AI based performance evaluation system 102 may include, but are not limited to, a web/cloud server and a media server.

In accordance with an embodiment, the AI based performance evaluation system 102 may be configured to deploy the ML model 104 to use output of the ML model to generate real or near-real time inferences, take decisions, or output prediction results. The ML model 104 may be deployed on the AI based performance evaluation system 102 once the ML model 104 is trained on the AI based performance evaluation system 102 for classification task associated with performance evaluation of operation resources of an organization.

In accordance with one embodiment, the ML model 104 may correspond to a first pre-trained machine learning model. In accordance with an embodiment, the first pre-trained machine learning model may correspond to an attention based deep neural network model that classifies an operation resource into a particular category of performance evaluation. Examples of the attention based deep neural network model includes, but not limited to, Long Short-Term Memory (LSTM), LSTM-GRU (Long Short-Term Memory-Gated Recurrent Units) of Neural Network. The ML model 104 may be configured to determine one or more features for each of the plurality of performance parameters. The ML model 104 may be configured to determine one or more features in order to assist the AI based performance evaluation system 102 to create the one or more feature vectors.

In accordance with another embodiment, the ML model 104 may correspond to a second machine learning model. The ML model 104 may be trained by assigning weights to the one or more features associated with the each of the plurality of performance parameters based on a predefined evaluation criterion. The predefined evaluation criterion may include one or more of complexity of issues, an expertise level and a resolution quality of issues, and wherein high weights are assigned to one or more features from the set of features associated with the complexity of issues, and the resolution quality of issues as compared to the expertise level.

The server 106 may include suitable logic, circuitry, interfaces, and/or code that may be configured to store, maintain, and execute one or more software platforms and programs, such as AI programs and machine learning programs, data associated with performance parameters, and one or more databases (such as the database 108) that include, without limitation, historical data. Although in FIG. 1, the AI based performance evaluation system 102 and the server 106 are shown as two separate entities, this disclosure is not so limited. Accordingly, in some embodiments, the entire functionality of the server 106 may be included in the AI based performance evaluation system 102, without a deviation from scope of the disclosure.

The external device 110 may include suitable logic, circuitry, interfaces, and/or code that may be configured to facilitate communication of one or more users with the AI based performance evaluation system 102. The external device 110 may be capable of communicating with the AI based performance evaluation system 102 via the network 112. The external device 110 and the AI based performance evaluation system 102 are generally disparately located. In accordance with an embodiment, the external device 110 may be configured to transmit text-based, voice-based, and/or video-based communications that are stored and executed by the AI based performance evaluation system 102 that provides performance evaluation of operation resources.

The functionalities of the external device 110 may be implemented in portable devices, such as a high-speed computing device, and/or non-portable devices, such as an application server. Examples of the external device 110 may include, but are not limited to, a computing device, a smart phone, a mobile device, a laptop, a smart watch, an MP3 player, a personal digital assistant (PDA), an e-reader, and a tablet. In accordance with an embodiment, the AI based performance evaluation system 102 may interact with the server 106 or the external device 110 over the network 112 for sending and receiving various types of data.

The network 112 may include a communication medium through which the AI based performance evaluation system 102, the server 106, and the external device 110 may communicate with each other. Examples of the network 112 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the environment 100 may be configured to connect to the network 112, in accordance with various wired and wireless communication protocols. Examples of such wired and wireless communication protocols may include, but are not limited to, a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

In operation, the AI based performance evaluation system 102 may be configured to receive the plurality of performance parameters associated with a set of operation resources. The AI based performance evaluation system 102 may be further configured to determine a set of features for each of the plurality of performance parameters. The AI based performance evaluation system 102 may be further configured to create one or more feature vectors corresponding to each of the plurality of performance parameters, based on the set of features determined for each of the plurality of performance parameters. In accordance with an embodiment, the one or more feature vectors may be created based on a first pre-trained machine learning model.

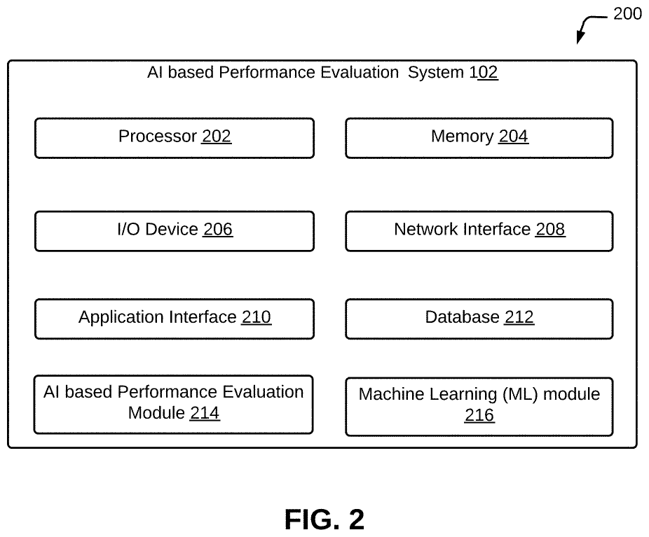

Further, the AI based performance evaluation system 102 may assess the one or more feature vectors. The AI based performance evaluation system 102 may then classify each of the set of operation resources into one of a set of performance categories. In accordance with an embodiment, the set of performance categories may include an excellent performer category, a good performer category, an average performer category, and a bad performer category. Thereafter, the AI based performance evaluation system 102 may evaluate the performance of at least one of the set of operation resources, based on an associated category in the set of performance categories. In order to evaluate the performance, the AI based performance evaluation system 102 may compute ranks for each operation resource from the set of operation resources categorized within an associated performance category. Based on the computed ranks, the AI based performance evaluation system 102 may rank each operation resource from the set of operation resources associated with each of the set of performance categories. This is further explained in detail in conjunction with FIG. 2 to FIG. 9.

Referring now to FIG. 2, a functional block diagram of an exemplary AI based performance evaluation system for evaluating performance of operation resources is illustrated, in accordance with an embodiment of the present disclosure. FIG. 2 is explained in conjunction with FIG. 1.

With reference to FIG. 2, there is shown a functional block diagram 200 of the AI based performance evaluation system 102. The AI based performance evaluation system 102 may include a processor 202, a memory 204, an input/output (I/O) device 206, a network interface 208, an application interface 210, a database 212, and modules, namely, an AI based performance evaluation module 214 and a machine learning (ML) module 216.

The modules 214 and 216 described herein may be implemented as software modules that may be executed in a cloud-based computing environment of the AI based performance evaluation system 102.

The ML module 216 of the AI based performance evaluation system 102 may include one or more machine learning models (such as, a first machine learning model, and a second machine learning model), as part of, for example, a software application of the performance evaluation system 102 that can classify the set of operation resources into one of a set of performance categories. In accordance with an embodiment, the processor 202 may be communicatively coupled to the memory 204, the I/O device 206, the network interface 208, the application interface 210, the database 212, the AI based performance evaluation module 214 and the ML module 216.

Elements and features of the AI based performance evaluation system 102 may be operatively associated with one another, coupled to one another, or otherwise configured to cooperate with one another as needed to support the desired functionality, as described herein. For ease of illustration and clarity, the various physical, electrical, and logical couplings and interconnections for the elements and the features are not depicted in FIG. 2. Moreover, it should be appreciated that embodiments of AI based performance evaluation system 102 will include other elements, modules, and features that cooperate to support the desired functionality. For simplicity, FIG. 2 only depicts certain elements that relate to the techniques described in more detail below.

The processor 202 may include suitable logic, circuitry, interfaces, and/or code that may be configured to process data associated with performance parameters corresponding to operation resources. In accordance with an embodiment, the processor 202 may evaluate the performance of each of the set of operation resources based on a plurality of performance parameters associated with the set of operation resources. The processor 202 may be implemented based on a number of processor technologies, which may be known to one ordinarily skilled in the art. Examples of implementations of the processor 202 may be a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, Artificial Intelligence (AI) accelerator chips, a co-processor, a central processing unit (CPU), and/or a combination thereof. The processor 202 may be communicatively coupled to, and communicates with, the memory 204.

The memory 204 may include suitable logic, circuitry, and/or interfaces that may be configured to store instructions executable by the processor 202. Additionally, the memory 204 may be configured to store program code of one or more machine learning models and/or the software application that may incorporate the program code of the one or more machine learning models. The memory 204 may be configured to store any received data or generated data associated with storing, maintaining, and executing the AI based performance evaluation system 102, such as, but not limited to, the plurality of performance categories, the one or more feature vectors, ranks for each operation resources from the set of operation resources, and a predefined evaluation. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, and/or interfaces that may be configured to act as an I/O interface between a user and the AI based performance evaluation system 102. The I/O device 206 may further act as an I/O interface between a Subject Matter Expert (SME) and the AI based performance evaluation system 102. The I/O device 206 may include various input and output devices, which may be configured to communicate with different operational components of the AI based performance evaluation system 102. The I/O device 206 may be configured to communicate data between the AI based performance evaluation system 102 and one or more of the server 106, and the external device 110.

By way of an example, the user may provide inputs, i.e., the plurality of performance parameters via the I/O device 206. In addition, the I/O device 206 may be configured to provide ranks to the operation resources based on performance evaluation of the operation resources by the AI based performance evaluation system 102. Further, the I/O device 206 may be configured to display results (i.e., the set of performance category associated with each of the set of operation resources) based on the performance evaluation by the AI based performance evaluation system 102, to the user. In some embodiments, the AI based performance evaluation system 102 may ingest the one or more performance parameters via the I/O devices 206.

Further, for example, in some embodiments, the AI based evaluation device 102 may render intermediate results (e.g., one or more feature vectors created for each of the set of operation resources, the set of performance categories, and one or more features determined for each of the plurality of performance parameters) or final results (e.g., classification of each of the set of operation resources in one of the set of performance categories, and results of evaluation of each of the set of set of operation resources) to the user(s) via the I/O devices 206. The user may correspond to, without limitation, a manager, a reviewer, a supervisor, or an operation resource. Examples of the I/O device 206 may include, but are not limited to, a touch screen, a keyboard, a mouse, a joystick, a microphone, and a display screen.

The network interface 208 may include suitable logic, circuitry, interfaces, and/or code that may be configured to facilitate different components of the AI based performance evaluation system 102 to communicate with other devices, such as, the server 106 and the external device 110 in the environment 100, via the network 112. The network interface 208 may be configured to implement known technologies to support wired or wireless communication. Components of the network interface 208 may include, but are not limited to an antenna, a radio frequency (RF) transceiver, one or more amplifiers, a tuner, one or more oscillators, a digital signal processor, a coder-decoder (CODEC) chipset, an identity module, and/or a local buffer.

The network interface 208 may be configured to communicate via offline and online wireless communication with networks, such as the Internet, an Intranet, and/or a wireless network, such as a cellular telephone network, a wireless local area network (WLAN), personal area network, and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), LTE, time division multiple access (TDMA), Bluetooth, Wireless Fidelity (Wi-Fi) (such as IEEE 802.11, IEEE 802.11b, IEEE 802.11g, IEEE 802.11n, and/or any other IEEE 802.11 protocol), voice over Internet Protocol (VoIP), Wi-MAX, Internet-of-Things (IoT) technology, Machine-Type-Communication (MTC) technology, a protocol for email, instant messaging, and/or Short Message Service (SMS).

The application interface 210 may be configured as a medium for a user (such as an SME) to interact with the AI based performance evaluation system 102. The application interface 210 may be configured to have a dynamic interface that may change in accordance with preferences set by the user and configuration of the AI based performance evaluation system 102. In some embodiments, the application interface 210 may correspond to a user interface of one or more applications installed on the AI based performance evaluation system 102. For communications between the AI based performance evaluation system 102 and the user (such as, the SME), the application interface 210 may use text application interfaces, audio call application interfaces, and video call application interfaces.

The database 212 may include suitable logic, circuitry, and/or interfaces that may be configured to store program instructions executable by the processor 202, the AI based performance evaluation module 214, the ML module 216, operating systems, and/or application-specific information, such as logs and application-specific databases. The database 212 may include a computer-readable storage media for carrying or having computer-executable instructions or data structures stored thereon. Such computer-readable storage media may include any available media that may be accessed by a general-purpose or special-purpose computer, such as the processor 202, the AI based performance evaluation module 214 and the ML module 216.

The database 212 may store data associated with performance parameters, data associated with operation resources, performance evaluation data, training data associated with machine learning models. The database 212 may generally be stored in the memory 204, and may be accessed and searched by the AI based performance evaluation module 214. The database 212 may serve as a repository for storing data processed, received, and generated by the modules 214-216. The data generated as a result of the execution of the modules 214-216 may be stored in the database 212.

By way of an example, and not limitation, the database 212 may use computer-readable storage media that includes tangible or non-transitory computer-readable storage media including, but not limited to, Compact Disc Read-Only Memory (CD-ROM) or other optical disk storage, magnetic disk storage or other magnetic storage devices (e.g., Hard-Disk Drive (HDD)), flash memory devices (e.g., Solid State Drive (SSD), Secure Digital (SD) card, other solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media.

The AI based performance evaluation module 214 may include suitable logic, circuitry, and/or interfaces that may be configured to evaluate the performance of at least one of the set of operation resources.

The machine learning module 216 may include suitable logic, circuitry, and/or interfaces that may be configured to classify the set of operation resources into one of a set of performance categories and ranking each operation resource from the set of operation resources for each of the set of performance categories. The machine learning module 216 may use the first pre-trained machine learning model that corresponds to a classification machine learning model, such as, but not limited to, Long-Short-Term-Memory (LSTM) based models and Gated Recurring Units (GRU) based models. The machine learning module 216 may also use the second pre-trained machine learning model that correspond to, but not limited to, a graph based neural network model and a ranking based machine learning model (such as, Rank Net). The second machine learning model may be trained by assigning weights to the one or more features associated with the each of the plurality of performance parameters based on a predefined evaluation criterion.

The ML module 216 may facilitate progressive performance improvement of the AI based performance evaluation system 102. This is typically performed by examining output data based on input data to determine the effect of the input data on the output data. Thereafter, various algorithms associated with machine learning models (such as, the first pre-trained machine learning model, and the second pre-trained machine learning model) may adjust the processing of the input data to result in desired output data.

In practice, the AI based performance evaluation module 214, the machine learning module 216, and/or the application interface 210 may be implemented with (or cooperate with) the at least one processor 202 to perform at least some of the functions and operations described in more detail herein. In this regard the AI based performance evaluation module 214, the machine learning module 216, and/or the application interface 210 may be realized as suitably written processing logic, application program code, or the like.

During operation, the AI based performance evaluation module 214 may be configured to receive the plurality of performance parameters associated with each of the set of operation resources as input data. The plurality of performance parameters may include, but is not limited to, at least one of type of issues solved, priority of the issues solved, complexity of issues, resolution quality of issues, types of support received from peers, types of support provided to peers, feedback or rating received from managers, expertise level, technical skills, positive feedback data, negative feedback data, neutral feedback data of each of the set of operation resources.

In accordance with an embodiment, complexity of the issues may correspond to complexity in solving the issue. The resolution quality of the issues may be based on, without limitation, whether the issue occurs again in a short span of time. In accordance with an embodiment, the AI based performance evaluation system 102 may be configured to use the performance parameter corresponding to the technical skills of the operation resources to identify at least one operation resource of similar skill set.

The AI based performance evaluation module 214 may be configured to pre-process the input data of the plurality of performance parameters with ordinal values into numerical values. For example, the performance parameter corresponding to ticket issue complexity may be high, medium and low value which is converted to 3, 2 and 1 respectively by the AI based performance evaluation module 214. Further, in another example, feedback or rating received from managers may take any values between 1 to 5. ‘1’ may represent lowest rating received from managers, while ‘5’ may represent highest rating received from managers. In accordance with an embodiment, the rating may be provided by managers based on resolution quality of issues. Moreover, in some embodiments, definition of lowest and highest may be different.

In accordance with an embodiment, the input data of the plurality of performance parameters with ordinal values may be converted into a passable format for a first pre-trained machine learning model by using one hot representation for the input data 202. The one hot representation (also known as one hot embedding) may map input data 202 which may be a categorical value data into a Neural Network passable format. Such format may allow to train an embedding layer of the first pre-trained machine learning model for each of the plurality of performance parameters. The one hot representation may represent a low dimensional embedding which on being fed to hidden layers of the first pre-trained machine learning model can handle a much smaller size of preprocessed input data as compared to the input data with ordinal values.

Further, the ML module 216 may be configured to determine one or more features for each of the plurality of performance parameters corresponding to the pre-processed input data. In accordance with an embodiment, the ML module 216 may be configured to determine one or more features based on the first pre-trained machine learning model. As will be appreciated, the first pre-trained machine learning model may correspond to a deep neural network model (for example, an attention based deep neural network model and a Convolution Neural Network (CNN) model).

In accordance with an embodiment, the ML module 216 may be further configured to create one or more feature vectors corresponding to the determined one or more features. In accordance with another embodiment, the ML module 216 may be configured to create one or more feature vectors based on the first pre-trained machine learning model. The feature vectors created for each of the plurality of performance parameters may be stored in the database 212 for further computation. It may be noted that the process of storing the feature vectors in the database 212 may continue, until the feature vector corresponding to each of the plurality of performance parameters is created and stored.

In accordance with an embodiment, the ML module 216 may be configured to assess each of the one or more feature vectors. In an embodiment, the ML module 216 may assess each of the one or more feature vectors, based on the first pre-trained machine learning model.

The ML module 216 may be further configured to classify each of the set of operation resources into one of a set of performance categories, based on the assessment of each of the one or more feature vectors. The performance categories may include an excellent performer, a good performer, an average performer and a bad performer. In accordance with an embodiment, the ML module 216 may classify the set of operation resources into one of: the excellent performer, the good performer, the average performer and the bad performer, based on the assessing of the one or more feature vectors. Further, the ML module 216 may be configured to transmit a result of classification of the set of operation resources to the AI based performance evaluation module 214.

The AI based performance evaluation module 214 may be configured to receive the result of classification from the ML module 212. Further, the AI based performance evaluation module 214 may be configured to evaluate the performance of at least one of the set of operation resources. The evaluation module 214 may evaluate the performance of at least one of the set of operation resources based on an associated category in the set of performance categories, in response to the classification. In accordance with an embodiment, output data corresponding to the evaluation of the performance of at least one of the set of operation resources may be rendered on the external device 110. Such output data may facilitate identification of operation resources in need of training on a particular technology. Further, the output data may provide insights for collaboration amongst operation resources of an organization.

In order to evaluate performance of at least one of the set of operation resources, the ML module 216 may be configured to compute ranks for each operation resource from the set of operation resources categorized within an associated performance category for each of the set of performance categories. In an embodiment, the ML module 216 may compute ranks using the second machine learning model. In accordance with an embodiment, the second machine learning model may correspond to a ranking based neural network model (for example, Rank net). By way of an example, the ML module 216 may compute ranks for each operation resource from the set of operation resources based on the predefined evaluation criteria.

In accordance with an embodiment, high weights are assigned to one or more features from the set of features associated with the complexity of issues, and the resolution quality of issues as compared to the expertise level of the operation resources, by using the second machine learning model.

In accordance with an exemplary embodiment, the ML module 216 may be configured to compute re-rank of operation resources under a same category (say, an “Excellent Performer” category). For example, it may be possible that there exist two operation resources under the “Excellent Performer” category, however, the two operation resources may be compared for a number of positive feedbacks and a number of negative feedbacks.

In accordance with another embodiment, the operation resources providing a good quality of solution for issues and high complexity issues may be given more attention as compared to their counterpart operation resources.

In accordance with an embodiment, the ML module 216 may rank each operation resource from the set of operation resources for each of the set of performance categories, based on the computed ranks. In an embodiment, the ranking module 218 may provide ranks for each operation resource in order to evaluate performance of each operation resource from the set of operation resources.

In particular, as will be appreciated by those of ordinary skill in the art, the modules 214-216 for performing the techniques and steps described herein may be implemented in the AI based performance evaluation system 102, either by hardware, software, or combinations of hardware and software. For example, suitable code may be accessed and executed by the one or more processors on the AI based performance evaluation system 102 to perform some or all of the techniques described herein. Similarly, application specific integrated circuits (ASICs) configured to perform some or all of the processes described herein may be included in the one or more processors on the host computing system. Even though FIGS. 1-2 describe about the AI based performance evaluation system 102, the functionality of the components of the AI based performance evaluation system 102 may be implemented in any computing devices.

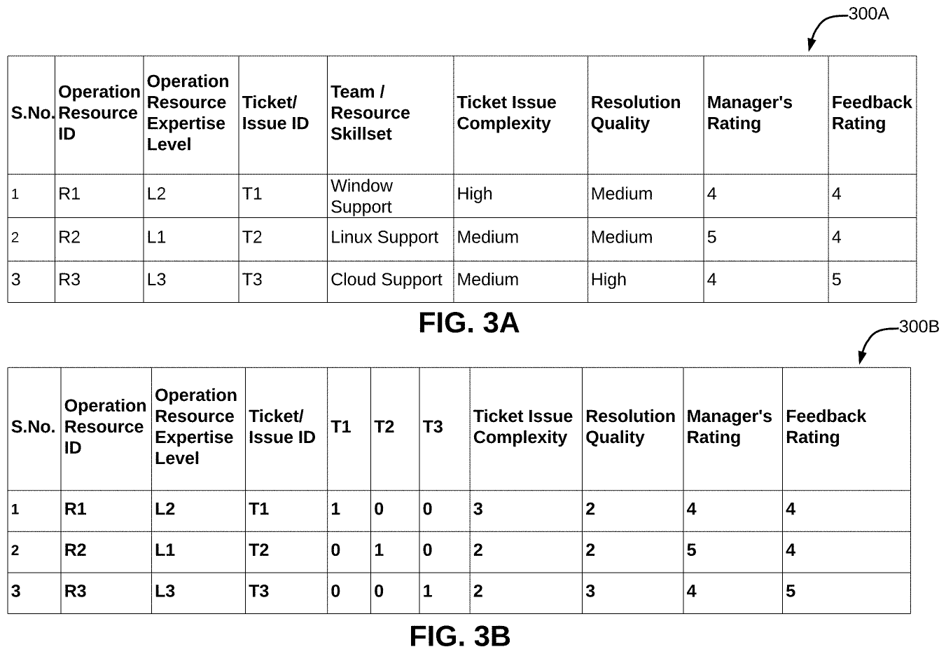

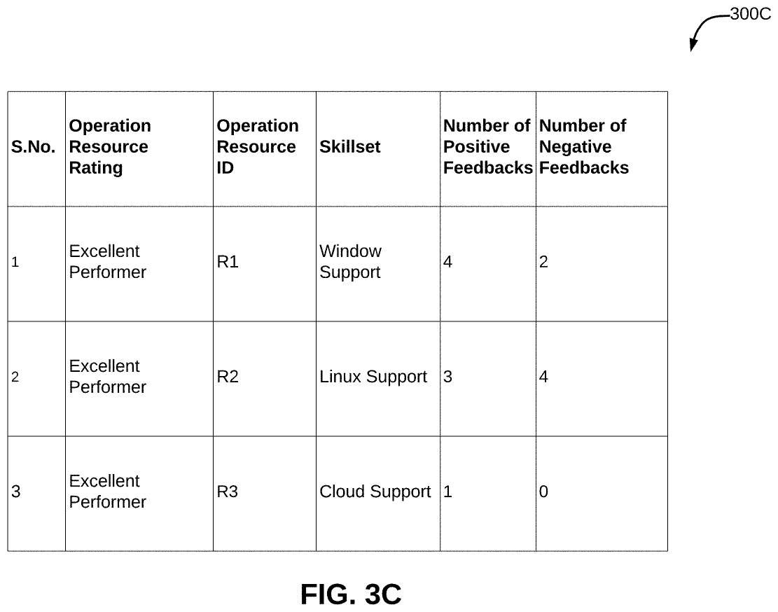

Referring now to FIG. 3A-3C, a tabular representation of input data corresponding to the plurality of performance parameters is illustrated, in accordance with some exemplary embodiments of the present disclosure. FIG. 3A-3C is explained in conjunction with FIG. 1 to FIG. 2.

With reference to FIG. 3A, the tabular representation 300A of a dataset (the input data) corresponding to the plurality of performance parameters for a set of operation resources is shown. The dataset may depict the plurality of performance parameters captured or received as the input data by the AI based performance evaluation system 102 for each of the set of operation resources order to evaluate performance of each of the set of operation resources.

The dataset in the tabular representation 300A includes operation resource ID, operation resource expertise level, ticket/issue identifier (ID), team/resource skillset, ticket issue complexity, resolution quality, manager's rating and feedback rating. In present table 300A, the set of operation resources may correspond to a set of three operation resources with ID of R1, R2 and R3.

In accordance with an embodiment, the operation resource R1 is level L2 resource of skill set windows track and worked upon ticket of High complexity with quality of delivery (or resolution quality) as medium along with feedback rating (customer's/user's rating) of 4. Here, the feedback rating may correspond to a rating or feedback provided by an end-user on basis of resolution for issues provided by the operation resource. In accordance with an embodiment, manager's rating may be provided by manager of the operation resource that has been provided over a period of time based on performance evaluated for the operation resource. In accordance with an embodiment, the feedback rating and manager's rating column can take any values between 1 and 5, 1 being lowest and 5 being highest. However, in some embodiment, definition of lowest and highest could be different. The AI based performance evaluation system 102 is order agnostic and independent of specific order of valued being implemented.

The AI based performance evaluation system 102 may also implement a scenario where operational resources may work and have solved multiple tickets of varying complexities, such as, high or medium successfully. In such a case, an operation resource solving such issues or tickets may be given more preference than their counterparts. For example, such operation resources may be promoted to next higher level, like an operation resource at L2 level may be promoted to L3 level.

In accordance with an embodiment, the AI based performance evaluation system 102 may use an attention based deep neural network architecture that classifies an operational resource into a particular category of performance evaluation by using the dataset (the input data) corresponding to the plurality of performance parameters for a set of operation resources. Here, a category of performance evaluation can be anything depending on evaluation policies and criteria of an organization. As an example, one of possible categories could be “Excellent Performer”, “Good Performer”, “Average Performer” and “Bad Performer”. The Excellent Performer may refer to a group of operational resources who have received top most rating during evaluation and the Bad Performer may refer to a group of operational resources who have received lowest rating during evaluation. The remaining categories may belong to a group of operational resources who are either average or more than average.

The dataset populated in the table 300A may not be suitable as a passable format for a neural network, such as the first pre-trained machine learning model. Hence, the dataset populated in the table 300A may be pre-processed by the AI based performance evaluation system 102 as shown in FIG. 3B.

The tabular representation 300B may represent numerical values of the plurality of performance parameters captured or received for each of the set of operation resources. The AI based performance evaluation system 102 may be configured to convert input data with ordinal values as shown in FIG. 3A into numerical values. As an example, column with name “resolution quality” have values such as 1, 2 and 3 where “1” may replace “Low”, “2” may replace “Medium” and “3” may replace “High”. In some other embodiments, one-hot representation (also referred as one hot embeddings) of ordinal values may be generated by the AI based performance evaluation system 102 where new features/columns may be introduced equal to number of unique values in columns of the tabular representation 300A. For example, the columns of performance parameters with multiple values (such as, Column: Technology used where a single operation resource is skilled in multiple technologies) may be converted to unique numeric values. In order to represent values numerically for the performance parameters, the AI based performance evaluation system 102 may be configured to convert such values into one-hot representation.

Further, in n-hot representation, embedding layer of the first trained machine learning model may have vector representation for a number of dimensions equal to number of unique values (T1 to T3 of 300B) in certain columns of 300A. Column T1′, ‘T2’, and ‘T3’ may represent unique numerical values based on skillset of the operation resource. By way of an example, the performance parameter “Team/Resource Skillset” in a column of 300A may be represented numerically in T1 to T3 of 300B, such as, Window Support: [1 0 0], Linux Support: [0 1 0], Cloud Support: [0 0 1].

In accordance with an embodiment, AI based performance evaluation system 102 may use an attention based deep learning recurrent neural network, such as, but not limited to, a Long Short-Term Memory (LSTM), a Long Short-Term Memory-Gated Recurrent Units (LSTM-GRU), a Long Short-Term Memory-Convolution Neural Network (LSTM-CNN) to take the processed form of an input data as shown in 300B and classify operational resources to one of the performance categories.

FIG. 3C illustrates a tabular representation 300C of input data corresponding to the plurality of performance parameters for re-ranking operational resources under same performance category, in accordance with some exemplary embodiments.

The dataset in the tabular representation 300C includes operation resource rating, operation resource ID, skillset, a number of positive feedbacks, a number of negative feedbacks. The number of negative feedbacks and the number of positive feedbacks received by the operation resources may depend on tickets or issues worked upon by the operation resources.

With reference to FIG. 3C, each operation resource with operation resource ID R1, R2, and R3 represented in the tabular representation 300C may be initially classified in the excellent performance category. However, the skillset, the number of positive feedbacks, the number of negative feedbacks of each operation resource is different. Therefore, each operation resource classified under the excellent performance category may be re-ranked.

In accordance with an embodiment, initially operation resources can be ranked on basis of number of positive feedbacks or number of negative feedbacks received over period of time. By way of an example, in tabular representation 300C, for operation resource R1, the number of positive feedbacks is highest as compared to operation resources R2 and R3. The number of negative feedbacks is highest for R2. R3 have not received any number of negative feedback but rather only positive feedback. Therefore, R1 should be ranked highest than other two operation resources.

The AI based performance evaluation system 102 may be configured to convert input data with ordinal values as shown in FIG. 3C into numerical values as a passable format for the second pre-trained machine learning model. The AI based performance evaluation system 102 may be configured to rank each operation resource from the set of operation resources for each of the set of performance categories to evaluate the performance of each operation resource from the set of operation resources using the second pre-trained machine learning model. In accordance with an embodiment, the second pre-trained machine learning model may correspond to a ranking based model, such as, Rank Net.

In some embodiments, the number of positive feedbacks and the number of negative feedbacks may be combined together using machine learning methods, but not limited to, Regression, and LSTM to generate a single value that includes both of the features corresponding to negative feedbacks and positive feedbacks. For example, such new feature can be calculated using equation (1):

New Feature column=A*(Number of Positive Feedbacks)+B*(Number of Negative Feedbacks)+C (1)

wherein A, B and C are coefficients and their values would decide on what percentage of each feature may be used during model training.

In accordance with an embodiment, a separate machine learning model may be trained for each value of “operational resource rating”. In other words, a separate machine learning model for each of “Excellent Performer”, “Good Performer”, “Average Performer” and “Bad Performer” may be used.

In some embodiments, a new feature may correspond to one of a mean, a median, a harmonic mean of both types of feedbacks (negative feedbacks and positive feedbacks) as shown in equation (2), (3) and (4) respectively:

Mean(Number of Positive feedback, Number of negative feedback)=(Number of positive feedback+number of negative feedback)/2 (2)

Median(Number of Positive feedback, Number of negative feedback)=(Number of positive feedback+Number of negative feedback)/2 (3)

Harmonic mean(Number of Positive feedback, Number of negative feedback)=1/Number of Positive Feedback+1/Number of Negative Feedback (4)

In some embodiments, the AI based performance evaluation system 102 may also capture neutral feedback data, that is, a feedback that cannot be categorized into positive feedback and negative feedback. For example, ‘Okay’ can be considered as neutral feedback where manager or reviewer respond with Okay which doesn't signify the positive feedback and the negative feedback.

In some embodiments, the AI based performance evaluation system 102 may have some more features and few of features may be a combination of other features which cannot be deduced directly by looking into the input data corresponding to performance parameters. In such a scenario, regression or other similar type of technique may be used to select a feature that could be combination of other features.

For example, a new feature can be calculated using equation (5).

New Feature column=A*(Feature 1)+B*(Feature 2)+C (5)

wherein A, B and C are coefficients, and values of A, B and C may decide on what percentage of each feature (Feature 1 and Feature 2) is used during machine learning model training.

The AI based performance evaluation system 102 may be configured to render output data on the external device 110 based on performance evaluation of at least one of the set of operation resources. Such output data may be used by some other operation resource or manager looking for assistance from another operation resource or to assist operation resource in future. In certain scenario, one operation resource may be of different team in the same organization and can use the output data to find an operation resource of specific domain/technical skillset.

In certain other scenario, an operation resource or a manager who needs help or assistance from another operation resource may leverage the AI based performance evaluation system 102. By way of an example, the operation resource or the manager may ask query like “Can you help me to find out operation resource who is an expert in handling windows track related issues?” via the I/O devices 206 of the AI based performance evaluation system 102. As a response, a system that includes employee data (associated with, without limitation, operation resources and managers) may be integrated with the AI based performance evaluation system 102 to connect via REST API (Representational State Transfer Application Programming Interface) for fetching details of the operation resources and render/display the response using the I/O devices 206.

In some embodiments, the AI based performance evaluation system 102 may also record assistance provided by one operational resource to another operational resource. Such data associated with assistance may be very useful for another AI—based collaboration system. Any employee collaboration system can leverage this information to enhance collaboration between operation resources. This collaboration information between operational resources can also be used to generate vector representation for each of operational resources as an input to find out resources with similar features.

In accordance with an embodiment, the AI based performance evaluation system 102 may use a graph based neural network to identify or update feedback rating of the operational resources. Embedding of each node in the graph may be generated based on neighboring nodes in the graph as similar to word or sentence embedding in Natural language Processing (NLP) problems.

The determined features of the operational resources may be represented by nodes in a graph and construct an edge if there has been any collaboration between them. In accordance with an embodiment, any random set of connected nodes may be extracted from the graph using any graph algorithms, such as, but not limited to, Random Walk and use them to generate embeddings for neighboring and target nodes. In some embodiments, the AI based performance evaluation system 102 may also use BERT (Bi-directional Encoder Representations from Transformer) embedding (if there is any textual feature) as well to generate low dimensional vector representation of node (operational resource). Therefore, the AI based performance evaluation system 102 may also be used to find out operational resources with similar interest, skillset, and capabilities. Further, the AI based performance evaluation system 102 may also be integrated with an employee training system where it can automatically trigger a relevant training for operations resources.

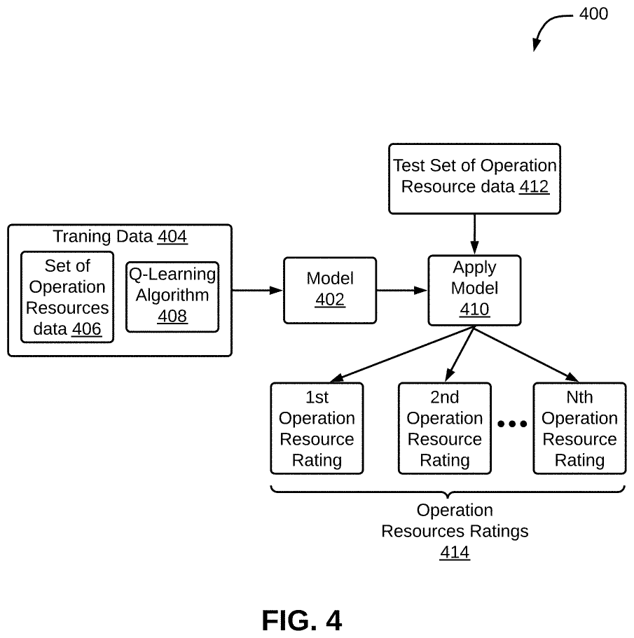

Referring now to FIG. 4, a trained AI based performance evaluation system based on a reinforcement learning is illustrated, in accordance with an exemplary embodiment. FIG. 4 is explained in conjunction with FIG. 1 to FIG. 3C.

There is shown a model 402, training data 404 with a set of operation resource data 406 and Q-learning algorithm 408, apply model 410, a test set of operation resource data 412, and operation resources ratings 414. In accordance with an embodiment, the model 402 may correspond to a trained performance evaluation system, such as the AI based performance evaluation system 102. In accordance with an embodiment, the model 402 may be exposed to new training data 404 when the model 402 has never been through earlier training process. The model 402 may leverage any issue generation system which will generate issues or tickets randomly and agents in reinforcement learning will try to solve those issues.

As a result, the model 402 may learn to identify optimal reward function that will maximize reward for end goal of issue resolution. In accordance with an embodiment, the set of operation resource data 406 may correspond to information associated with each of the set of operation resources. The information may include, without limitation, a performance category associated with each of the set of operation resources, computed ranks, and the plurality of performance parameters. Further, the Q-value algorithm 408 (such as, but not limited to, temporal difference algorithm) may be used to calculate a Q-value corresponding to each of the set of operation resources. The Q-value may be calculated based on the reinforcement learning approach. In addition, the feedback associated with each of the set of operation resources may be predicted based on reinforcement learning approach.

In an embodiment, the Q-value represents preference of a particular operation resource over other operation resources from the set of operation resources across all values of the feedback or rating. In other words, the Q-value may represent probability of one operation resource being preferred over the other operation resource across different values of the feedback or rating. Based on the calculated Q-value, the model 402 may penalize the manager or supervisor for giving incorrect feedback or rating to one operation resource over the other operation resources from the set of operation resources. Moreover, the Q-values of each of the set of operation resources along with the associated feedback or rating may be used to maximize reward. If that is not true, then the trained AI based evaluation system will be penalized.

Based on the training data received, the model 402 may be generated or trained. Such trained model (referred as the model 402) may be applied over a test set of operation resources' data 412 via the apply model 410. The test set of operation resources' data may correspond to information associated with a new set of operation resources. The rating provided to each of the test set of operation resources' data may be depicted as operation resources rating 414. In accordance with an embodiment, the first pre-trained machine learning model corresponds to a Q network. The Q network may be configured to receive as input an input observation corresponding to set of operation resources' data and an input action and to generate an estimated future reward (or penalty) from the input in accordance with each of the plurality of performance parameters associated with the set of operation resources.

In accordance with another embodiment, the first pre-trained machine learning model may correspond to a Q network (not labelled in FIG. 4), and the Q network may be configured to receive as input an input observation, an input action and to generate an estimated future reward from the input in accordance with each of the plurality of performance parameters associated with the set of operation resources. In accordance with an embodiment, the first pre-trained machine learning model may be configured to compute a Q value of each of the set of operation resources using a reinforcement learning algorithm.

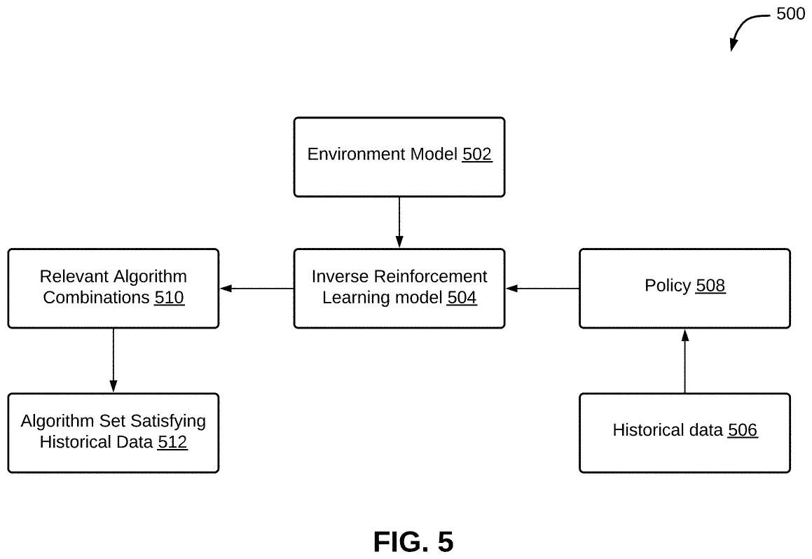

Referring now to FIG. 5, a trained AI based performance evaluation system that uses inverse reinforcement learning is illustrated, in accordance with an exemplary embodiment. FIG. 5 is explained in conjunction with FIG. 1 to FIG. 4. There is shown an environmental model 502, an inverse reinforcement learning model 504, historical data 506, policy 508, relevant algorithm combinations 510, and algorithm set satisfying historical data 512.

The reinforcement learning based trained evaluation system may correspond to the environment model 502. The environment model 502 may correspond to the apply model 410. The environment model 502 may employ the inverse reinforcement learning model 504. The inverse reinforcement learning model 504 may be configured to utilize the historical records 506 to penalize and boost rating and ranking of each of a set of operation resources in an organization. The historical records 506 may use various policies, such as the policy 508 to penalize and boost rating and ranking of each of the set of operation resources.

In an embodiment, the historical records 506 may contain detailed information of each of the set of operation resources from various teams in an organization along with the issues or tickets being solved by each of the set of operation resources and feedback data provided by manager, team lead, customer or end-user over issue resolution. Such feedback data may be used to penalize or boost feedback rating and feedback ranking of each of the set of operational resources. Thereafter, the inverse reinforcement learning model 504 may identify combination or set of algorithms and function that will define architecture of deep learning based recurrent neural network variations and define hyperparameter for different layers of a neural network. The combination or set of algorithms and function may be represented as relevant algorithm combination 510. In an embodiment, the inverse reinforcement learning model 504 may recommend more than one combination of set of algorithms and functions.

Further, the recommended combination of set of algorithms and functions may be evaluated based on the reinforcement learning approach in order to accept one combination of set of algorithms and functions. Moreover, one combination of set of algorithms and functions may be accepted when it satisfies evaluation of historical records represented as algorithm set satisfying historical records 512. Once the one combination of set of algorithms and functions is accepted, a new environment may be created for the environment model 502. In addition, the inverse reinforcement learning model 504 may recommend optimal values of hyperparameters corresponding to each combination of set of algorithms and functions. Further, a machine learning model trained over optimal values of hyperparameters may be validated against historical data received from an existing environment of the environment model 502. This process is known as model hyperparameter tuning. In accordance with an embodiment, the trained AI based performance evaluation system may select algorithm combination that provides an optimal architecture of a graph based neural network, a recurrent neural network (RNN) architecture and a ranking based neural network architecture to generate feedback rating and ranking as per historical data 506 provided.

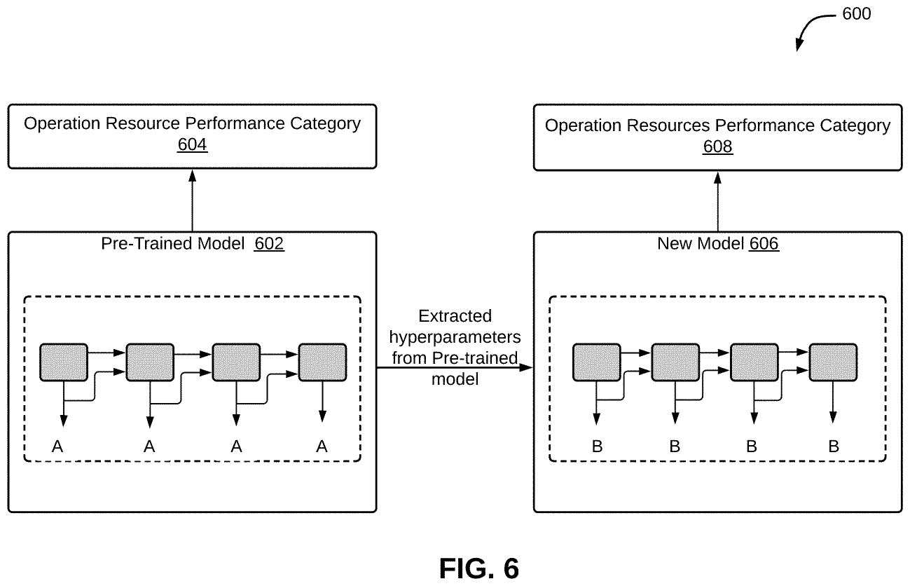

Referring now to FIG. 6, a transfer learning approach to create a new environment for a trained AI based performance evaluation system is depicted, in accordance with an exemplary embodiment. FIG. 6 is explained in conjunction with FIG. 1 to FIG. 5.

There is shown a pre-trained model 602, an operation resource performance category 604 associated with the pre-trained model 602, a new model 606, and an operation resource performance category 608 associated with the pre-trained model 606.

In an embodiment, the transfer learning approach may be used to leverage training of an AI based performance evaluation system (such as, the AI based performance evaluation system 102) from previous implementation to new implementation. The new model 606 may correspond to the new environment generated for the environment model 502 based on acceptance of one combination of the set of algorithms and functions. The new model 606 may receive the optimal values of hyperparameters represented as extracted pre-trained hyperparameters from the pre-trained model 602.

Thereafter, the new model 606 may classify a new set of operation resources in one of the set of performance categories based on the optimal values of hyperparameters received from the pre-trained model 602. In an embodiment, the transfer learning approach may enable gathering of knowledge from an existing environment or implementation of the AI based performance evaluation system 102. The knowledge corresponds to optimal values (i.e., the one or more feature vectors) of the plurality of performance parameters and hyperparameters required for the implementation of the AI based performance evaluation system 102. Further, the optimal values of the plurality of performance parameters and hyperparameter may be utilized to develop the new environment for the AI based evaluation system 102. This may require less training time as compared to starting from scratch or from vanilla model. The vanilla model may correspond to a standard, usual, and unfeatured version of the AI based evaluation system 102.

In accordance with an embodiment, the AI based evaluation system 102 may be configured to modify the first pre-trained machine learning model (such as, the pre-trained model 602) with transferable knowledge for a target system to be evaluated. The transferable knowledge may correspond to optimal values associated with the one or more feature vectors corresponding to each of the plurality of performance parameters.

In accordance with an embodiment, the AI based performance evaluation system 102 may be configured to tune the first pre-trained machine learning model (such as, the pre-trained model 602) using specific characteristics of the target system to create a target model (such as, the new model 606). In accordance with an embodiment, the AI based evaluation system 102 may be configured to evaluate the target system performance using the target model (such as, the new model 606) to predict system performance of the target system for evaluating performance of a set of operation resources from an organization.

In accordance with an embodiment, the AI based performance evaluation system 102 may be configured to modify the first pre-trained machine learning model (not shown in FIG. 6) with transferable knowledge for a target system to be evaluated. The transferable knowledge corresponds to optimal values associated with the one or more feature vectors corresponding to each of the plurality of performance parameters. In accordance with an embodiment, the AI based performance evaluation system 102 may be configured to tune the first pre-trained machine learning model using specific characteristics of the target system to create a target model and evaluate the target system performance using the target model to predict system performance of the target system.

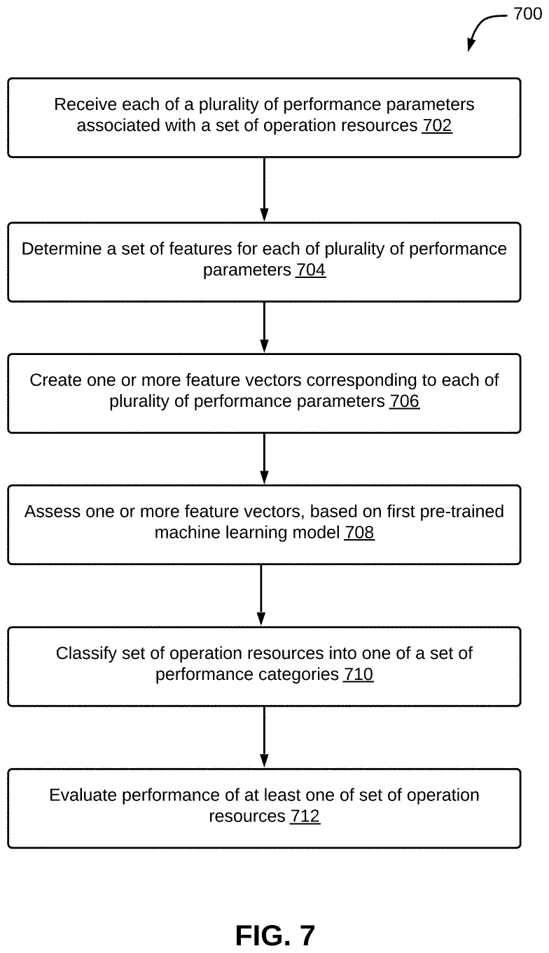

FIG. 7 is a flowchart that illustrates an exemplary method for evaluating performance of operation resources using Artificial Intelligence (AI), in accordance with an embodiment. With reference to FIG. 7, there is shown a flowchart 700. The operations of the exemplary method may be executed by any computing system, for example, by the AI based performance evaluation system 102 of FIG. 1. The operations of the flowchart 700 may start at 702 and proceed to 704.

At 702, each of a plurality of performance parameters associated with a set of operation resources may be received. In accordance with an embodiment, the AI based performance evaluation module 214 of the AI based performance evaluation system 102 may be configured to receive each of a plurality of performance parameters associated with a set of operation resources.

In accordance with an embodiment, the one or more performance parameters may comprise at least one of type of issues solved, priority of the issues solved, complexity of issues, resolution quality of issues, types of support received from peers, types of support provided to peers, feedback or rating received from managers, expertise level, technical skills, positive feedback data, negative feedback data, neutral feedback data of each of the set of operation resources.

At 704, a set of features for each of the plurality of performance parameters may be determined. In accordance with an embodiment, the machine learning module 216 of the AI based performance evaluation system 102 may be configured to determine the set of features for each of the plurality of performance parameters, based on the each of a plurality of performance parameters.

In accordance with an embodiment, determining a feature from the set of features further comprises receiving positive feedback data and negative feedback data corresponding to each of the plurality of performance parameters, to determine the feature associated with each of the set of operation resources.

In accordance with an embodiment, determining the feature from the set of features further comprises computing one of: a mean, a median, a harmonic mean, and any machine learning algorithm based on the positive feedback data and the negative feedback data received corresponding to each of the plurality of performance parameters. In accordance with an embodiment, determining a feature from the set of features further comprises combining two or more features from the set of features determined.

At 706, one or more feature vectors corresponding to each of the plurality of performance parameters may be created. In accordance with an embodiment, the machine learning module 216 of the AI based performance evaluation system 102 may be configured to create one or more feature vectors corresponding to each of the plurality of performance parameters, based on the set of features determined for each of the plurality of performance parameters. In accordance with an embodiment, the one or more feature vectors may be created based on a first pre-trained machine learning model.

In accordance with an embodiment, the first pre-trained machine learning model may correspond to a Q network. In accordance with an embodiment, the Q network may be configured to receive as input an input observation, an input action and to generate an estimated future reward from the input in accordance with each of the plurality of performance parameters associated with the set of operation resources.

In accordance with an embodiment, the first pre-trained machine learning model may be configured to compute a Q value of each of the set of operation resources using a reinforcement learning algorithm. The Q value may correspond to probability of one operation resource from the set of operation resources being preferred over other operation resources from the set of operation resources.

In accordance with an embodiment, the machine learning module 216 of the AI based performance evaluation system 102 may be configured to modify the first pre-trained machine learning model with transferable knowledge for a target system to be evaluated. The transferable knowledge corresponds to optimal values associated with the one or more feature vectors corresponding to each of the plurality of performance parameters. In accordance with an embodiment, the machine learning module 216 of the AI based performance evaluation system 102 may be configured to tune the first pre-trained machine learning model using specific characteristics of the target system to create a target model and evaluate the target system performance using the target model to predict system performance of the target system.

At 708, one or more feature vectors may be assessed based on the first pre-trained machine learning model. In accordance with an embodiment, the machine learning module 216 of the AI based performance evaluation system 102 may be configured to assess the one or more feature vectors, based on the first pre-trained machine learning model.

At 710, set of operation resources may be classified into one of a set of performance categories. In accordance with an embodiment, the machine learning module 216 of the AI based performance evaluation system 102 may be configured to classify the set of operation resources into one of a set of performance categories based on the assessing of the one or more feature vectors. In accordance with an embodiment, the set of performance categories includes an excellent performer category, a good performer category, an average performer category, and a bad performer category.

At 712, performance of at least one of the set of operation resources may be evaluated. In accordance with an embodiment, the AI based performance evaluation module 214 of the AI based performance evaluation system 102 may be configured to evaluate the performance of at least one of the set of operation resources, based on an associated category in the set of performance categories, in response to the classifying.

In accordance with an embodiment, the AI based performance evaluation module 214 may be further configured to identify at least one operation resource from the set of operation resources for imparting training to the at least one operation resource to bridge technical skill gap, based on the evaluated performance of the at least one operation resource of the set of operation resources. In accordance with an embodiment, for evaluating the performance of each of the set of operation resources, algorithms and associated parameters may be identified, based on an inverse reinforcement learning technique.

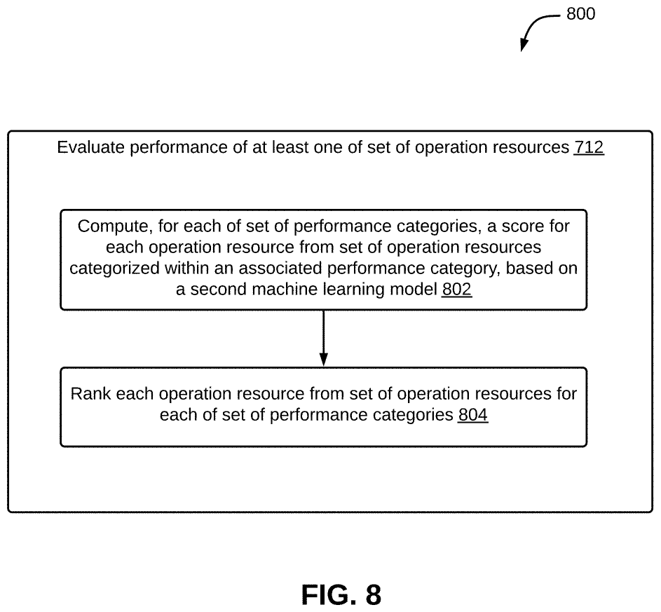

FIG. 8 is a flowchart that illustrates an exemplary method for ranking operation resources for performance evaluation of the operation resources, in accordance with an embodiment.

With reference to FIG. 8, there is shown a flowchart 800. The operations of the exemplary method may be executed by any computing system, for example, by the AI based performance evaluation system 102 of FIG. 1. The operations of the flowchart 800 may start at 802 and proceed to 804.

At 802, for each of the set of performance categories, a score may be computed for each operation resource from the set of operation resources categorized within an associated performance category. In accordance with an embodiment, the machine learning module 216 of the AI based performance evaluation system 102 may be configured to compute, for each of the set of performance categories, a score for each operation resource from the set of operation resources categorized within an associated performance category, based on a second machine learning model which is trained on determined set of features associated with the each of a plurality of performance parameters for one of the set of performance categories.

In accordance with an embodiment, training of the second machine learning model may further comprise assigning weights to each of the set of features associated with the each of the plurality of performance parameters based on a predefined evaluation criterion. In accordance with an embodiment, the predefined evaluation criterion comprises one or more of complexity of issues, an expertise level and a resolution quality of issues. In accordance with an embodiment, high weights may be assigned to one or more features from the set of features associated with the complexity of issues, and the resolution quality of issues as compared to the expertise level.

At 804, each operation resource from the set of operation resources may be ranked for each of the set of performance categories. In accordance with an embodiment, the machine learning module 216 of the AI based performance evaluation system 102 may be configured to rank each operation resource from the set of operation resources for each of the set of performance categories, based on the computed ranks to evaluate the performance of each operation resource from the set of operation resources.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It will be appreciated that, for clarity purposes, the above description has described embodiments with reference to different functional units and processors. However, it will be apparent that any suitable distribution of functionality between different functional units, processors or domains may be used without detracting from the disclosure. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present disclosure has been described in connection with some embodiments, it is not intended to be limited to the specific form set forth herein. Rather, the scope of the present disclosure is limited only by the claims. Additionally, although a feature may appear to be described in connection with particular embodiments, one skilled in the art would recognize that various features of the described embodiments may be combined in accordance with the disclosure.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

The disclosed system and method provide some advantages, like the disclosed system and the method may enable collaboration amongst operation resources of an organization based on performance evaluation. Further, the disclosed system and method may help managers or reviewers to proactively identify operation resources that may require training on a particular technology. In addition, the system and method may evaluate performance of an operation resource comprehensively, based on several performance parameters, such as assistance provided by an operation resource to other operation resources in the organization. Such comprehensive evaluation of performance by the AI based performance evaluation system 102 may facilitate identification of distinguished operation resources in the organization and similarly aid in providing a necessary appraisal or rating to operation resources of the organization. Moreover, the system and method may help managers to find operation resources of a similar type of technical skills. Further, the system and the method may allow managers to fetch details of an operation resource based on performance parameters.

It will be appreciated that, for clarity purposes, the above description has described embodiments of the disclosure with reference to different functional units and processors. However, it will be apparent that any suitable distribution of functionality between different functional units, processors or domains may be used without detracting from the disclosure. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present disclosure has been described in connection with some embodiments, it is not intended to be limited to the specific form set forth herein. Rather, the scope of the present disclosure is limited only by the claims. Additionally, although a feature may appear to be described in connection with particular embodiments, one skilled in the art would recognize that various features of the described embodiments may be combined in accordance with the disclosure.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for evaluating performance of operation resources using Artificial Intelligence (AI), the method comprising:
receiving, by an AI based evaluation system, each of a plurality of performance parameters associated with a set of operation resources;
determining, by the AI based evaluation system, a set of features for each of the plurality of performance parameters, based on the each of a plurality of performance parameters;
creating, by the AI based evaluation system, one or more feature vectors corresponding to each of the plurality of performance parameters, based on the set of features determined for each of the plurality of performance parameters, wherein the one or more feature vectors are created based on a first pre-trained machine learning model;
assessing, by the AI based evaluation system, the one or more feature vectors, based on the first pre-trained machine learning model;
classifying, by the AI based evaluation system, the set of operation resources into one of a set of performance categories based on the assessing of the one or more feature vectors; and
evaluating, by the AI based evaluation system, the performance of at least one of the set of operation resources, based on an associated category in the set of performance categories, in response to the classifying.

2. The method of claim 1, further comprising:
identifying at least one operation resource from the set of operation resources for imparting training to the at least one operation resource to bridge technical skill gap, based on the evaluated performance of the at least one operation resource of the set of operation resources.

3. The method of claim 1, wherein determining a feature from the set of features further comprises:
receiving positive feedback data and negative feedback data corresponding to each of the plurality of performance parameters, to determine the feature associated with each of the set of operation resources.

4. The method of claim 3, wherein determining the feature from the set of features further comprises computing one of: a mean, a median and a harmonic mean, based on the positive feedback data and the negative feedback data received corresponding to each of the plurality of performance parameters.

5. The method of claim 1, wherein determining a feature from the set of features further comprises combining two or more features from the set of features determined.

6. The method of claim 1, wherein evaluating the performance comprises:
computing, for each of the set of performance categories, a score for each operation resource from the set of operation resources categorized within an associated performance category, based on a second machine learning model trained on determined set of features associated with the each of a plurality of performance parameters for one of the set of performance categories; and
ranking each operation resource from the set of operation resources for each of the set of performance categories, based on the computed ranks, to evaluate the performance of each operation resource from the set of operation resources.

7. The method of claim 6, wherein training of the second machine learning model further comprises assigning weights to each of the set of features associated with the each of the plurality of performance parameters based on a predefined evaluation criterion.

8. The method of claim 7, wherein the predefined evaluation criterion comprises one or more of complexity of issues, an expertise level and a resolution quality of issues, and wherein high weights are assigned to one or more features from the set of features associated with the complexity of issues, and the resolution quality of issues as compared to the expertise level.

9. The method of claim 1, wherein the one or more performance parameters comprise at least one of type of issues solved, priority of the issues solved, complexity of issues, resolution quality of issues, types of support received from peers, types of support provided to peers, feedback or rating received from managers, expertise level, technical skills, positive feedback data, negative feedback data, neutral feedback data of each of the set of operation resources.

10. The method of claim 1, wherein the set of performance categories includes an excellent performer category, a good performer category, an average performer category, and a bad performer category.

11. The method of claim 1, wherein evaluating the performance of each of the set of operation resources is based on an inverse reinforcement learning technique.

12. The method of claim 1, further comprising:
modifying the first pre-trained machine learning model with transferable knowledge for a target system to be evaluated, wherein the transferable knowledge corresponds to optimal values associated with the one or more feature vectors corresponding to each of the plurality of performance parameters;
tuning the first pre-trained machine learning model using specific characteristics of the target system to create a target model; and
evaluating the target system performance using the target model to predict system performance of the target system.

13. The method of claim 1, wherein the first pre-trained machine learning model corresponds to a Q network, and wherein the Q network is configured to receive as input an input observation, an input action and to generate an estimated future reward from the input in accordance with each of the plurality of performance parameters associated with the set of operation resources.

14. The method of claim 1, wherein the first pre-trained machine learning model is configured to compute a Q value of each of the set of operation resources using a reinforcement learning algorithm, and wherein the Q value corresponds to probability of one operation resource from the set of operation resources being preferred over other operation resources from the set of operation resources.

15. A system for evaluating performance of operation resources using Artificial Intelligence (AI), the system comprising:
a processor; and
a memory communicatively coupled to the processor, wherein the memory stores processor executable instructions, which, on execution, causes the processor to:
receive each of a plurality of performance parameters associated with a set of operation resources;
determine a set of features for each of the plurality of performance parameters, based on the each of a plurality of performance parameters;
create one or more feature vectors corresponding to each of the plurality of performance parameters, based on the set of features determined for each of the plurality of performance parameters, wherein the one or more feature vectors are created based on a first pre-trained machine learning model;
assess the one or more feature vectors, based on the first pre-trained machine learning model;
classify the set of operation resources into one of a set of performance categories based on the assessing of the one or more feature vectors; and
evaluate the performance of at least one of the set of operation resources, based on an associated category in the set of performance categories, in response to the classifying.

16. The system of claim 15, wherein the processor executable instructions cause the processor to identify at least one operation resource from the set of operation resources for imparting training to the at least one operation resource to bridge technical skill gap, based on the evaluated performance of the at least one operation resource of the set of operation resources.

17. The system of claim 15, wherein to determine a feature from the set of features, the processor executable instructions cause the processor to:
receive positive feedback data and negative feedback data corresponding to each of the plurality of performance parameters, to determine the feature associated with each of the set of operation resources.

18. The system of claim 15, wherein to determine the feature from the set of features, the processor executable instructions further cause the processor to compute one of: a mean, a median and a harmonic mean, based on the positive feedback data and the negative feedback data received corresponding to each of the plurality of performance parameters.

19. The system of claim 15, wherein to determine a feature from the set of features, the processor executable instructions further cause the processor to combine two or more features from the set of features determined.

20. A non-transitory computer-readable medium storing computer-executable instructions for contextually aligning a title of an article with content within the article, the stored instructions, when executed by a processor, cause the processor to perform operations comprising:
receiving each of a plurality of performance parameters associated with a set of operation resources;
determining a set of features for each of the plurality of performance parameters, based on the each of a plurality of performance parameters;
creating one or more feature vectors corresponding to each of the plurality of performance parameters, based on the set of features determined for each of the plurality of performance parameters, wherein the one or more feature vectors are created based on a first pre-trained machine learning model;
assessing the one or more feature vectors, based on the first pre-trained machine learning model;
classifying the set of operation resources into one of a set of performance categories based on the assessing of the one or more feature vectors; and
evaluating the performance of at least one of the set of operation resources, based on an associated category in the set of performance categories, in response to the classifying.
